(19) United States
(12) Patent Application Publication
(10) Pub. No.: US 2026/0197063 A1
(43) Pub. Date: Jul. 9, 2026

(54) UNIFIED UPLINK MULTIPLE-INPUT MULTIPLE-OUTPUT (MIMO) FRAMEWORK

(71) Applicant: QUALCOMM Incorporated, San Diego, CA (US)

(72) Inventors: Hyojin LEE, San Diego, CA (US); Yu ZHANG, San Diego, CA (US); Jing SUN, San Diego, CA (US); Jing JIANG, San Diego, CA (US)

(21) Appl. No.: 19/013,947

(22) Filed: Jan. 8, 2025

(51) Int. Cl. H04B 7/06; H04B 7/0413; H04W 72/21

(52) U.S. Cl. CPC H04B 7/0665; H04B 7/0413; H04W 72/21

(57) ABSTRACT

Certain aspects of the present disclosure provide techniques for wireless communications. An example method includes obtaining, from a network entity (NE), a first indication of at least one of a first precoding or a second precoding; and sending, to the NE, a second indication regarding a selected precoding of the first precoding or the second precoding, wherein the selected precoding is based on a precoding gain between the first precoding and the second precoding.

### INTRODUCTION

### Field of the Disclosure

Aspects of the present disclosure relate to wireless communications, and more particularly, to techniques for a low latency unified uplink multiple-input multiple-output (MIMO) framework.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications. The method includes obtaining, from a network entity (NE), a first indication of at least one of a first precoding or a second precoding; and sending, to the NE, a second indication regarding a selected precoding of the first precoding or the second precoding, wherein the selected precoding is based on a precoding gain between the first precoding and the second precoding.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts example communications signaling under a codebook (CB) based uplink (UL) multiple input-multiple output (MIMO) framework.

FIG. 6 depicts example communications signaling under a non-codebook (NCB) based UL MIMO framework.

FIG. 7 depicts example communications signaling between a user equipment (UE) and a network entity (NE) under a unified UL MIMO framework.

FIG. 8 depicts another example communications signaling between a UE and an NE under a unified UL MIMO framework.

FIG. 9 depicts an example modulation and coding scheme (MCS) information transmission under a unified UL MIMO framework.

FIG. 10 depicts an example table to derive delta MCS.

FIG. 11 depicts a method for wireless communications.

FIG. 12 depicts aspects of an example communications device.

### DETAILED DESCRIPTION

Aspects of the present disclosure provide apparatuses, methods, processing systems, and computer-readable mediums for a two-way low latency unified uplink (UL) MIMO framework.

MIMO refers to techniques to receive or send multiple signals simultaneously. At a receiver, MIMO may be implemented with multiple receive antennas or receive chains. At a transmitter, MIMO may be implemented with multiple transmit antennas or transmit chains. MIMO enables sending multiple data streams simultaneously. The general goal of MIMO is to increase or improve the signal range, reduce transmission errors, reduce power consumption, and reduce signal interference. UL MIMO refers to MIMO techniques used for data transmissions from a device such as a user equipment (UE) to a network entity (NE) such as a base station. Similarly, downlink (DL) MIMO refers to techniques used for data transmissions from an NE to a UE.

UL MIMO may be performed via codebook (CB) based techniques or non-codebook (NCB) based techniques. CB based techniques (CB MIMO techniques) use predefined precodings to map layers of a communication to transmit chains or antenna ports. CB MIMO techniques provide for a UE to transmit a reference signal, and for an NE to derive a precoding and other transmit parameters from the reference signal. The NE may transmit a UL grant to the UE indicating the precoding and the other transmit parameters, such that the UE can transmit a signal in accordance with the UL grant.

NCB based techniques (NCB MIMO techniques) provide for determination of a precoding based on dynamic channel signal information. NCB MIMO techniques use additional signaling between the NE and UE to derive the precoding. The precoding is determined from measurements by the UE, rather than from a CB with predefined precodings. The NE transmits a channel state information reference signal (CSI-RS) to a UE. The UE measures this DL signal to derive the precoding for the UL channel assuming tight reciprocity between the DL and UL channels. The UE indicates this precoding to the NE via a set of precoded reference signals. For example, if a maximum rank equals M and the number of antenna ports equals N, the UE transmits M SRS resources that are each precoded with a precoding vector of length N. The NE then transmits a UL grant that also indicates transmit parameters and selected precoded reference signals to the UE, such that the UE can transmit a signal in accordance with the UL grant using its own derived precoding. For example, the NE selects an R number of resources among the M SRS resources it received from the UE, for the UE to apply an N*R precoding matrix to its PUSCH transmission.

“Precoding” refers to the preprocessing of signals before they are transmitted to refine them to current channel conditions, such as to obtain better signal quality and reliability. For example, in the context of MIMO, a precoding may include a matrix that specifies a mapping of layers (e.g., data streams) of a communication to different antennas, antenna ports, or the like.

Each of these techniques has its advantages and disadvantages. CB MIMO techniques do not assume reciprocity between UL and DL. Reciprocity between UL and DL transmissions means that the characteristics of the UL and DL transmissions are generally similar in their signal characteristics, behavior, or conditions. For example, when reciprocity exists, a wireless device can generally infer channel characteristics that will be experienced by transmissions of the wireless device, by measuring a received signal. Adding to their simplicity, CB MIMO techniques can use low-resolution CBS, such as a precoding of limited complexity, which by reducing choice improves precoding selection efficiency and simplifies implementation. While the simplicity of CB MIMO techniques is computationally less expensive than NCB MIMO techniques and simplifies signaling, CB MIMO techniques may provide less precise precoding alignments than some other techniques, and precoding selection may be reduced since there are a limited number of precoding matrices to choose from. Less than optimal precoding selection reduces signal quality, strength, and reliability. Additional drawbacks of CB MIMO techniques include difficulty in supporting subband precoding. Subband precoding is the process of applying precoding at the subband granularity rather than across an entire channel bandwidth. The CB MIMO techniques also have limited flexibility to support different UE antenna architectures.

NCB MIMO techniques can use high-resolution precoding since NCB MIMO techniques are not limited by a CB, thereby increasing the addressable selection of precoding matrices relative to codebook-based precoding. Furthermore, NCB MIMO techniques allow subband precoding and can perform precoding at subband granularity rather than the entire channel bandwidth further increasing precoding precision. Additionally, NCB MIMO techniques enable gNB-transparent precoding in which the NE only signals an indication of selected reference signals (e.g., a sounding reference signal resource indicator) and does not necessarily know an underlying precoding used to transmit the selected reference signal, which simplifies implementation at the network.

However, NCB MIMO techniques may benefit from tight reciprocity when utilizing time division duplex (TDD) techniques. Additionally, NCB MIMO techniques are associated with longer latencies due to the additional signaling steps and processing compared to CB MIMO techniques. In NCB MIMO techniques the UE measures and processes the CSI-RS from the NE to obtain a precoding before it can send a set of precoded reference signals to the NE. The precoded reference signal set sent by the UE allows the NE to determine transmit parameters. The measuring and processing by the UE of the CSI-RS from the NE to obtain a precoding delays the transmission of the set of precoded reference signals by the UE increasing the latency of NCB MIMO techniques.

Aspects presented herein introduce a unified MIMO framework that offers the benefits of the high-resolution precoding of NCB MIMO techniques as well as the simplicity and low latency associated with CB MIMO techniques to produce low latency yet high quality MIMO transmissions.

The presented aspects of a unified MIMO framework provide improved MIMO techniques where a UE obtains a first indication from an NE. The first indication comprises at least one of a first precoding or a second precoding. The UE then sends to the NE, a second indication comprising the first precoding or the second precoding. The second indication is determined based on a precoding gain between the first precoding and the second precoding. The indication may be in the form of an MCS that allows the NE to decode UL transmission applying the MCS.

The presented unified MIMO framework allows the NE to signal a first precoding to the UE as well as a modulation and coding scheme (MCS). The UE may use the first precoding or may determine and use its own precoding, e.g., a second precoding, along with its own MCS for subsequent transmissions. The UE does not have to communicate the second precoding to the NE, and may only indicate information associated with the MCS.

Alternatively, the NE may signal both of the first precoding and the second precoding to the UE as well as associated MCSs for each of the first precoding and the second precoding, and the UE selects from the first or second precoding and its associated MCS for subsequent uplink transmissions. The UE may provide an indication of the selected MCS and/or precoding so that the NE can decode an uplink transmission from the UE.

The unified MIMO framework reduces delays and latency relative to NCB MIMO techniques by allowing the UE and the NE to decouple reference signal transmission from indication of the precoding. It does this by removing sequential dependencies between the reference signals, allowing them to occur closer in time, independently from each other, and in any order, thus reducing latencies and delays. For example, in NCB MIMO techniques, the UE first measures a first RS, then transmits a second RS using a precoding derived from the first RS, and then is scheduled with an uplink transmission using an adjustment of the precoding. The unified MIMO framework allows for the NE to receive the UE's uplink transmission without explicit knowledge of the precoding, and without receiving a prior reference signal from the UE indicating the precoding.

The unified MIMO framework also allows for the selection or determination of precoding by the UE improving overall signal quality, strength and reliability between the UE and NE based on UE-specific channel conditions. The improved signal quality between the UE and the NE improves connection reliability reducing packet losses and retransmissions.

Thus, the aspects presented beneficially improve latency relative to NCB MIMO techniques and improve MIMO performance relative to CB MIMO techniques.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

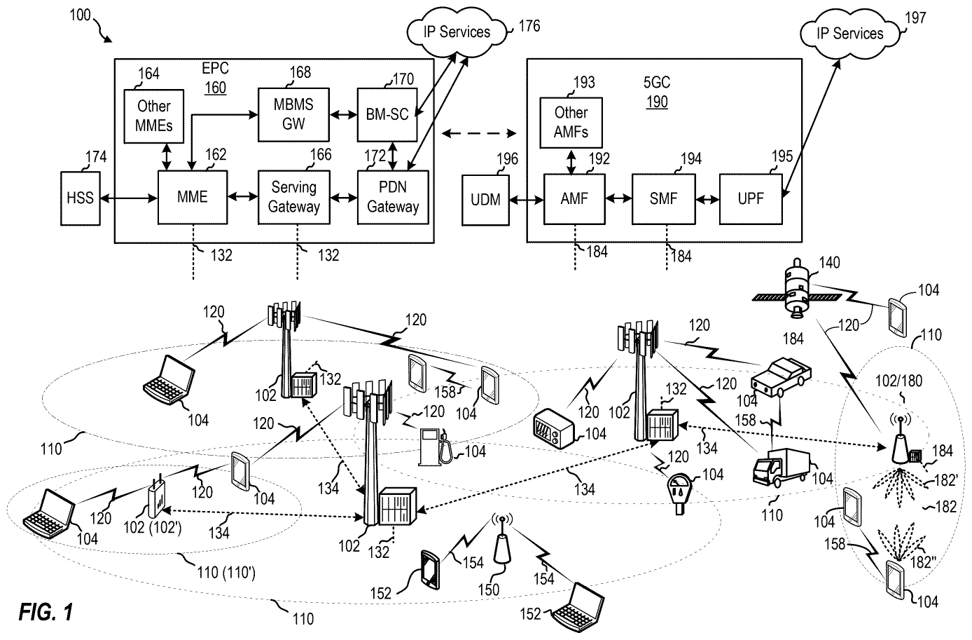

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

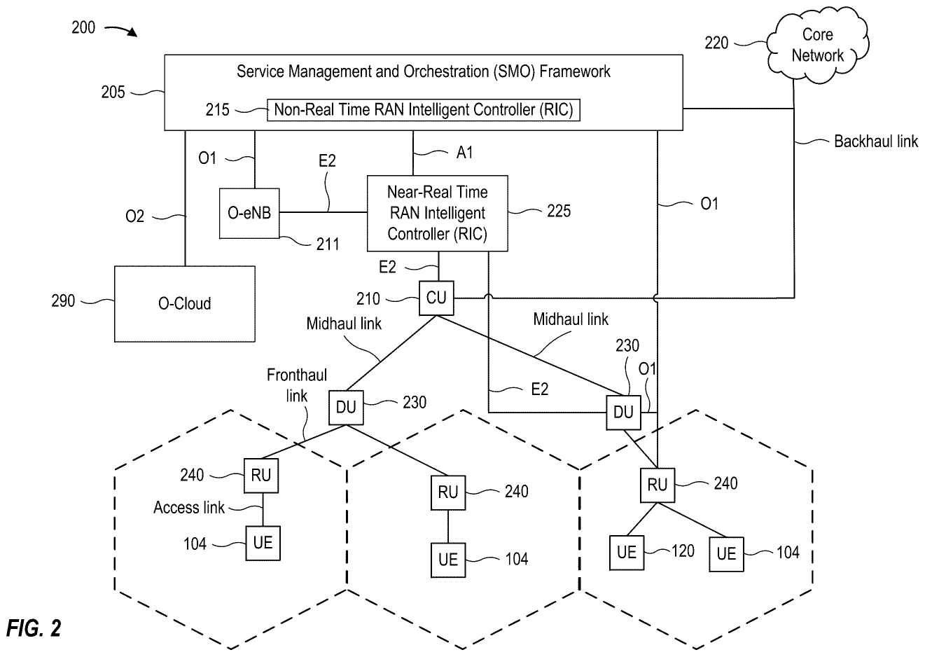

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

In some examples, BS 180 and UE 104 may communicate using precoding.

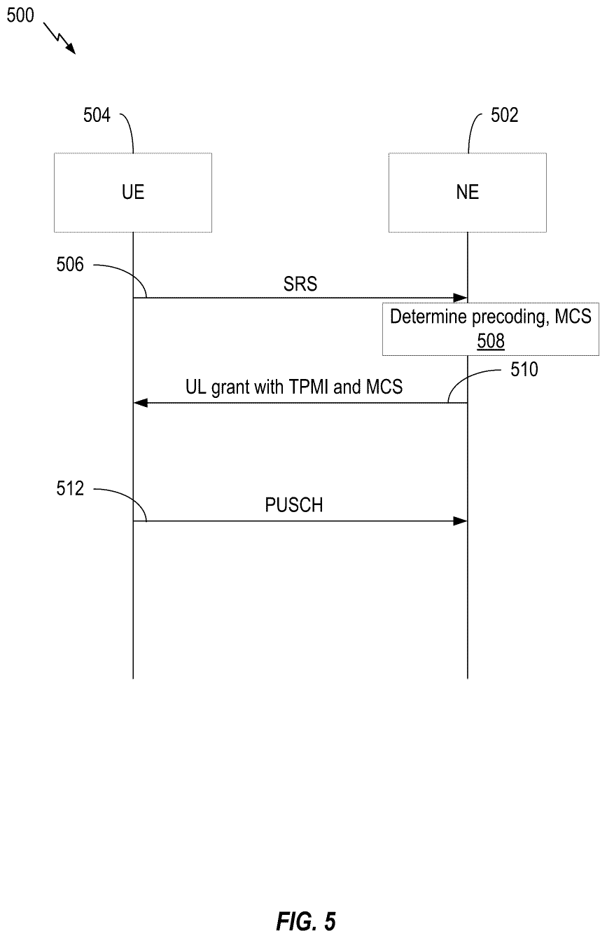

For example, precoding may support MIMO communication via multiple transmit chains or receive chains. Selection of precoding is described in more detail in connection with FIGS. 5-10.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

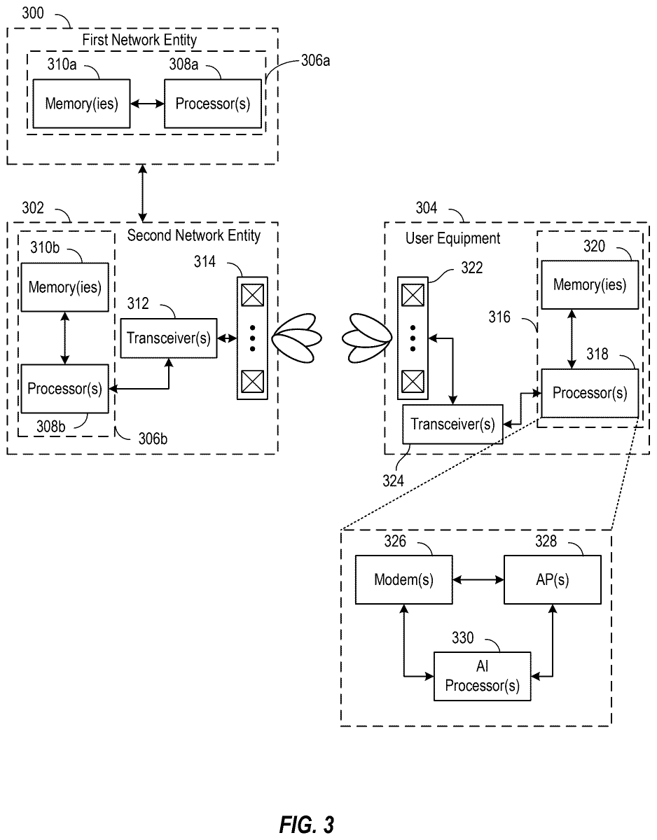

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3. The one or more antennas 314 may transmit or receive signals according to a precoding, which may map layers (e.g., data streams) of a communication to antennas 314 or transmit chains. The precoding can be determined at the second NE 302 and signaled to the UE 304, or determined at the UE 304, as described elsewhere herein.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor) according to a precoding, further processed by the one or more transceivers 324 (e.g., for SC-FDM), and transmitted to second network entity 302. Aspects described herein provide for the precoding to be determined at the UE 304, notwithstanding a different precoding signaled to the UE 304 by the second network entity 302. For example, the UE 304 may provide an indication of an MCS of the precoding such that the second network entity 302 can decode and demodulate the symbols transmitted by the UE 304.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

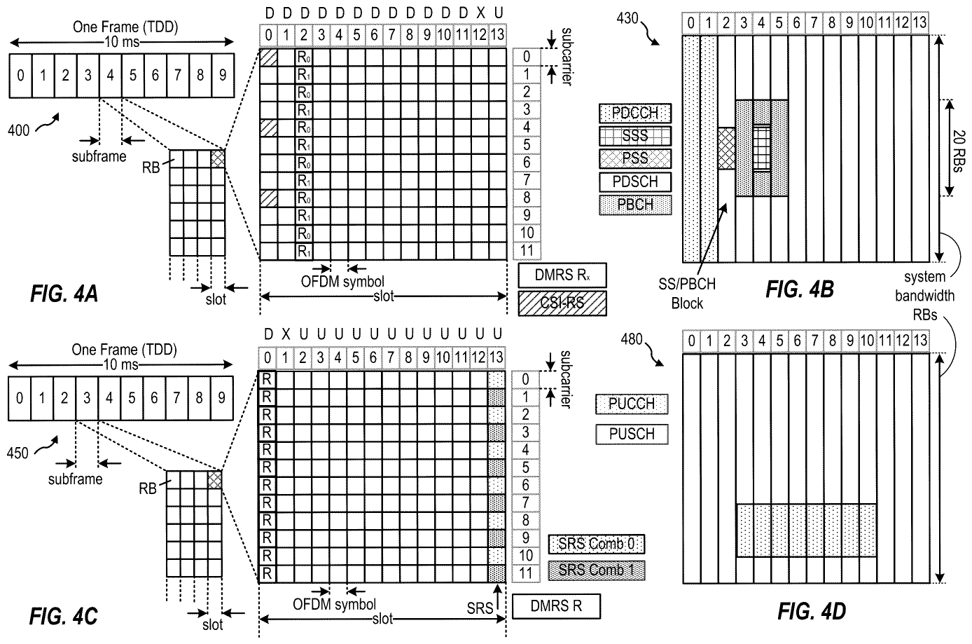

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI. In some examples described herein, the PUCCH can be embedded within or prefixed to the PUSCH.

### Aspects Related to UL MIMO Frameworks

FIG. 5 depicts an example communications signaling 500 under a CB MIMO techniques between an NE 502 and a UE 504.

In some aspects, the NE 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1 or the UE 304 depicted and described with respect to FIG. 3. However, in other aspects, the UE 504 may be another type of wireless communications device and the NE 502 may be another type of network entity or network node, such as those described herein. Note that any operations or signaling illustrated with dashed lines may indicate that that operation or signaling is an optional or alternative example.

The example communications signaling 500 begins at 506 with the UE 504 sending and the NE 502 receiving a sounding reference signal (SRS). The NE 502 measures the SRS at 506 to determine parameters regarding the channel, such as interference and noise information. For example, the NE 502 may determine channel conditions, such as a channel matrix, using the SRS.

At 508, based on the information derived from the SRS received at 506, the NE 502 determines a precoding and an MCS for UL signals. For example, based on the SRS symbols that arrive at the NE 502, the NE 502 selects a best precoding from a CB. In the example communications signaling 500, the NE 502 determines the precoding based on a CB that specifies precoding matrices to use based on various channel conditions derived from the SRS. The MCS may be a value such as an MCS index. The MCS index indicates a row of a table, and the row indicates a modulation scheme and a code rate for a communication. The MCS is calculated based on the given precoding selected by the NE 502. That is, a different precoding selection would result in a different MCS determination.

At 510, the NE 502 sends and the UE 504 receives a UL grant. The UL grant indicates the MCS and a transmitted precoding matrix indicator (TPMI) to indicate the precoding. For example, the TPMI may indicate a number of layers, a number of antenna ports, a maximum rank, a codebook, a precoding matrix, or a combination thereof.

At 512, the UE 504 sends and the NE 502 receives a PUSCH transmission on the granted UL resources, based on the TPMI and the MCS received at 510. The UE 504 performs the transmission via a precoding determined by the TPMI, e.g., by applying the precoding. The transmission uses a modulation scheme and code rate indicated by the MCS.

Advantages associated with the example communications signaling 500 include it being a simple two-way procedure (that is, involving two transmissions at 506 and 510), after which a PUSCH can be sent, without having to assume UL/DL reciprocity. However, because the determining of the precoding at 508 is based on a predefined CB, e.g., a low-resolution CB, it has a limited number of supported precodings.

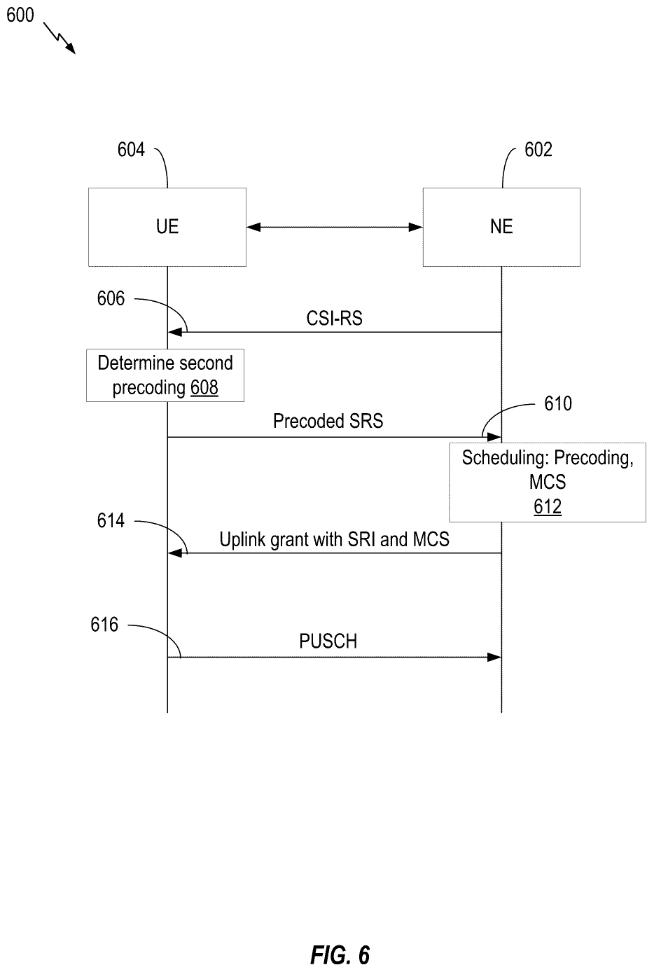

FIG. 6 depicts example communications signaling 600 under NCB MIMO techniques between an NE 602 and a UE 604.

In some aspects, the NE 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, the UE 604 may be another type of wireless communications device and NE 602 may be another type of network entity or network node, such as those described herein. Note that any operations or signaling illustrated with dashed lines may indicate that that operation or signaling is an optional or alternative example.

At 606, the NE 602 sends and the UE 604 receives a CSI-RS. The UE 604 may determine a channel condition based on the CSI-RS. For example, the UE 604 may compute a channel matrix and/or one or more CSI parameters based on the CSI-RS.

At 608, the UE 604 determines a precoding based on measurements of the CSI-RS received at 606. The UE 604 may use a channel matrix computed using the CSI-RS to determine the precoding.

At 610, the UE 604 sends and the NE 602 receives a set of precoded SRSs. Each precoded SRS is transmitted with a different precoding, such that the NE 602 can select an appropriate precoding based on measurements of the multiple SRSs.

The CSI-RS at 606 and the set of precoded SRSs at 610 are sequential in time because the precoding of each precoded SRS sent at 610 is based on the CSI-RS received at 606, which the UE 604 uses at 608 to determine the precoding. The sequential nature of these two transmissions 606 and 610, the dependency of the set of precoded SRSs on the CSI-RS, and the determination of the precoding at 608, incur delays and increase latency.

At 612, the NE 602 measures the set of precoded SRSs received at 610 to determine parameters regarding the channel and/or to derive an MCS (e.g., an MCS index). The NE 602 may select a precoded SRS based on measuring the set of precoded SRS. By selecting a precoded SRS, the NE 602 may implicitly select a precoding that supposed to be used for PUSCH transmission.

At 614, the NE sends, and the UE 604 receives a grant of UL resources along with the MCS and an SRS resource indicator (SRI). The SRI is a value that identifies the precoded SRS selected by the NE 602. Thus, the NE 602 can indicate a UE-determined precoding to the UE 604 by indicating a precoded SRS that was transmitted using the UE-determined precoding.

The UE 604 then sends a PUSCH transmission at 616 using the granted resources and the precoding determined at 608.

The advantages of the example communications signaling 600 include high-resolution precoding increasing the number of available precoding matrices, as well as allowing for the use of precoding at the subband granularity. However, the example communications signaling 600 is a more complex procedure with higher latencies in comparison to the example communications signaling 500 of FIG. 5. This is partly due to the example communications signaling 600 including three sequential transmissions at 606, 610, and 614 before a PUSCH can be transmitted.

### Example Signaling of Unified UL MIMO Frameworks

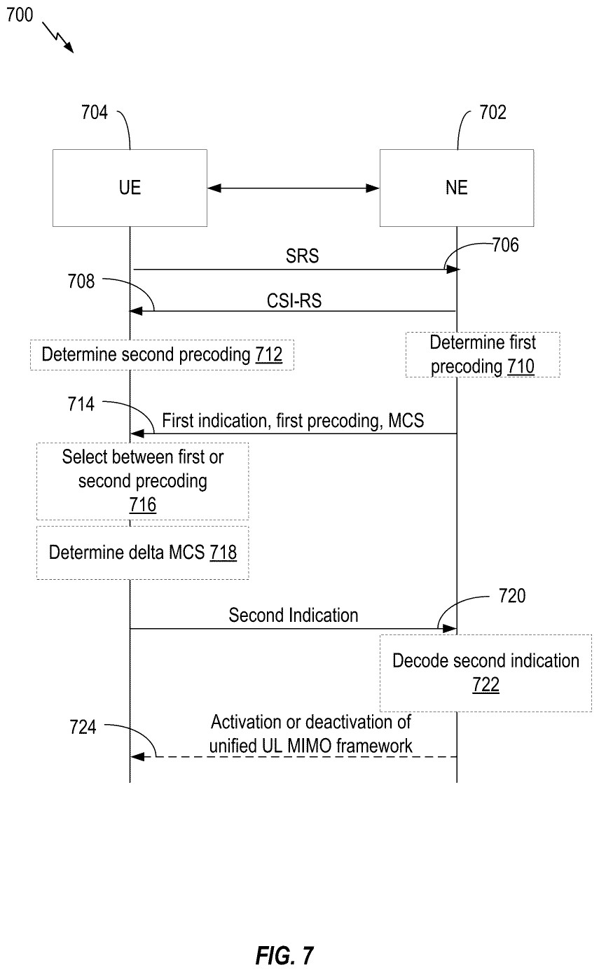

FIG. 7 depicts example communications signaling 700 between a UE 704 and an NE 702 using a unified UL MIMO framework. The example communications signaling 700 combines the benefits of the example communications signaling 500 of FIG. 5, with those of the example communications signaling 600 of FIG. 6. References herein to a unified UL MIMO framework may refer to one or more of the signaling operations described with regard to FIG. 7.

In some aspects, the NE 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, the UE 704 may be another type of wireless communications device and the NE 702 may be another type of network entity or network node, such as those described herein. Note that any operations or signaling illustrated with dashed lines may indicate that that operation or signaling is an optional or alternative example.

In some aspects, at 706, the UE 704 sends, and the NE 702, receives an SRS. In some aspects, at 708, the NE 702 sends and the UE 704 receives a CSI-RS. In some aspects, the transmission of the SRS and the transmission of the CSI-RS may occur near-simultaneously. In some aspects, these transmissions may occur independently of one another. In some aspects, one of these transmissions may occur immediately after the other. In some aspects, the CSI-RS at 708 may be sent before the SRS at 706. The usage of the unified UL MIMO framework may enable these transmissions to occur in close proximity to one another, thereby reducing latency.

In some aspects, at 710, the NE 702 determines a first precoding. This first precoding may be a CB-based precoding based on a defined CB and the SRS received at 706. In some aspects, the determination of the first precoding at 710 may be an example of the determination of the precoding at 508 of FIG. 5. The NE 702 at 710 may also determine a corresponding MCS (e.g., MCS index) for a PUSCH transmission, e.g., based on the SRS.

In some aspects, at 712, the UE 704 determines a second precoding based on the CSI-RS that the UE 704 received at 708. For example, the UE 704 may measure the CSI-RS to determine the second precoding. As another example, the UE 704 may compute the second precoding from a DL channel matrix derived from the CSI-RS. In this example, assuming channel reciprocity allows the UE 704 to determine the second precoding by using the channel conditions indicated by the CSI-RS. In some aspects, the determination of the second precoding at 712 may be an example of the determination of the precoding at 608 of FIG. 6. In some cases, the second precoding may be an optimal precoding.

At 714, the NE 702 sends and the UE 704 receives a first indication. The first indication may include a UL grant with a TPMI. The TPMI may indicate the first precoding determined by the NE 702 at 710. The first indication may also indicate the MCS (e.g., MCS index) determined at 710.

In some aspects, at 716, the UE 704 may select between the first precoding and the second precoding as a selected precoding. For example, the UE 704 may select a precoding, from the first precoding and the second precoding, that is expected to provide a threshold performance, such as a best performance (e.g., in terms of gain, throughput, or another metric). In some aspects, the UE 704 may select the second precoding as the selected precoding when a gain of the second precoding is greater than a gain of the first precoding by at least a threshold amount.

In some aspects, the UE 704 may determine a delta MCS based on the precoding selected at 716. For example, the first precoding may be associated with an MCS referred to as a reference MCS (indicated at 714). The second precoding may provide a higher gain at the UE 704 than the first precoding, and a difference in the gain of the first precoding and the gain of the second precoding is referred to herein as a precoding gain. The second gain may be associated with a second MCS, which may support a higher code rate and/or a more aggressive modulation scheme than the reference MCS due to the higher gain of the second precoding. The difference between the reference MCS and the second MCS is the delta MCS. If the first precoding is selected, then the delta MCS is zero since there is no precoding gain.

In some aspects, at 720, the UE 704 transmits a second indication, which may be a UL control information (UCI) simultaneously transmitted with PUSCH transmission on the granted UL resources indicated in the first indication at 714. The second indication may indicate, or may be associated with an indication of, the delta MCS determined at 718. In some aspects, the second indication comprises the delta MCS, e.g., an MCS difference relative to a reference MCS associated with the first precoding. In some aspects, where the UE 704 selects the first precoding at 718, the second indication indicates selection of the first precoding by indicating a delta MCS of zero (thus indicating no change relative to the reference MCS). In some aspects, where the UE 704 selects the second precoding at 718, the second indication indicates the second precoding by indicating a delta MCS associated with the second precoding. For example, the second indication may indicate, to the NE 702, an MCS to use to receive the PUSCH transmission on the granted UL resources. Thus, the NE 702 can determine an appropriate MCS whether the UE 704 selects the first precoding or the second precoding by reference to either the MCS signaled as part of the first indication or the delta MCS signaled at 720. The UE 704 may use the selected precoding from 718 for the transmission of the second indication at 720.

In some aspects, the second indication may include a UCI transmission. For example, the second indication may include a UCI transmission that indicates the delta MCS. In some aspects, the UCI transmission is on a UCI resource that is prefixed to the PUSCH transmission at 720. In some other aspects, the UCI transmission is on a UCI resource that is embedded within the PUSCH transmission at 720.

In some aspects, at 722, the NE 702 decodes and demodulates the second indication. For example, the NE 702 may first decode the UCI transmission, which may be possible because the UCI transmission may be separately encoded and modulated on a UCI resource (e.g., separately from the PUSCH transmission). The NE 702 may use an MCS indicated by the UCI transmission (which may be the reference MCS indicated in the first indication, or may be an MCS determined by the UE 704 and indicated at 720) to decode and demodulate the PUSCH transmission of the second indication. Thus, the NE 702 can determine the appropriate MCS based on the UCI transmission, and may then use this MCS to decode the PUSCH transmission.

In some aspects, the example communications signaling 700 can be activated or deactivated via signaling from the NE 702, e.g., at 724. For example, the NE 702 may activate the UE-side selection of precoding and indication of delta MCS prior to the UE's determination of the second precoding at 712. When the unified UL MIMO framework is deactivated, the UE 704 and/or the NE 702 may use CB MIMO techniques or the NCB MIMO techniques of FIGS. 5-6. This activation or deactivation signaling can be performed via RRC signaling, MAC signaling (e.g., a DL MAC control element (MAC-CE)), or downlink control information (DCI), for example, prior to determination of the second precoding or via the first indication.

In some aspects, when the UE 704 is incapable of applying the reciprocity-based precoding (e.g., when reciprocity cannot be assumed), the UE 704 may use a CB MIMO technique, e.g., of FIG. 5, to perform an uplink transmission. For example, the UE 704 may use the first precoding indicated by the first indication. When a unified MIMO framework is not configured or activated by RRC signaling (or if CB-based UL MIMO is affirmatively configured), the UE 704 operates with the CB MIMO techniques.

In some aspects, the NE 702 transmits a MAC-CE that indicates whether to apply the unified UL MIMO framework (e.g., to determine the second precoding and/or signal the delta MCS). When the MAC-CE indicates that the unified UL MIMO framework is activated, then the UE 704 determines the second precoding, selects the selected precoding, and signals the delta MCS (e.g., utilizes the unified UL MIMO framework). The UE 704 then transmits subsequent PUSCH communications, e.g., at 720, with a UCI transmission indicating a delta MCS as described above. For example, the UE 704 may transmit the subsequent PUSCH communications with the UCI transmission indicating the delta MCS after the UE 704 has transmitted an acknowledgement corresponding to the reception of the MAC-CE.

When a MAC-CE, e.g., at 724, indicates that the unified UL MIMO framework is deactivated, the UE 704 may transmit subsequent PUSCH communications using CB-based UL MIMO. For example, the UE 704 may transmit subsequent PUSCH communications using a precoding indicated by a TPMI of a UL grant and a MCS indicated by the UL grant. In some aspects, the UL grant in PDCCH indicates whether to apply unified UL MIMO frameworks to the PUSCH transmission at 720.

In some aspects, a UL grant (e.g., the first indication at 712) in DCI transmitted via a PDCCH indicates whether the UE 704 should apply the unified UL MIMO framework for a PUSCH transmission scheduled by the UL grant. When the UL grant indicates to apply the unified UL MIMO framework, the UE 704 applies the second precoding and transmits, with the PUSCH transmission, an indication of the delta MCS (e.g., via a UCI resource with the PUSCH transmission, as described below). When the UL grant does not indicate to apply the unified UL MIMO framework, the UE 704 performs CB-based UL MIMO without the indication of the delta MCS (e.g., the UE 704 applies the first precoding indicated by the TPMI of the UL grant).

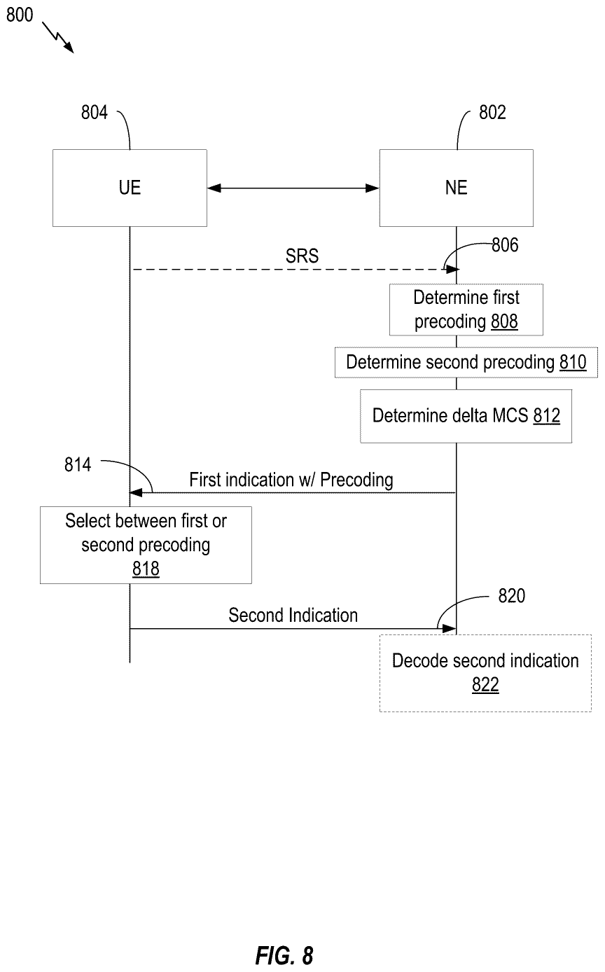

FIG. 8 depicts another example communications signaling 800 between a UE 804 and an NE 802 using a unified UL MIMO framework. The example communications signaling 800 combines the benefits of the example communications signaling 500 of FIG. 5, with those of the example communications signaling 600 of FIG. 6. Any step or block of the example communications signaling 800 may be combined with any step or block of the example communications signaling 700 to achieve the disclosed aspects herein. FIG. 8 differs from FIG. 7 in that, in FIG. 8, the second precoding and delta MCS are determined at the NE 802.

In some aspects, the NE 802 may be an example of the BS 102 depicted and described with respect to FIG. 1, the first network entity 300 or the second network entity 302 depicted and described with respect to FIG. 3, or a disaggregated base station depicted and described with respect to FIG. 2. The NE 802 may correspond to the NE 702 of FIG. 7. Similarly, the UE 804 may be an example of UE 104 depicted and described with respect to FIG. 1 or the UE 304 depicted and described with respect to FIG. 3. The UE 804 may correspond to the UE 704 of FIG. 7. However, in other aspects, the UE 804 may be another type of wireless communications device and the NE 802 may be another type of network entity or network node, such as those described herein. Note that any operations or signaling illustrated with dashed lines may indicate that that operation or signaling is an optional or alternative example.

In some aspects, at 806, the UE 804 sends and the NE 802 receives an SRS. In some aspects, at 808, the NE 802 measures the SRS and determines a first precoding. This first precoding may be a CB-based precoding based on a defined CB. In some aspects, the determination of the first precoding at 808 corresponds to determination of the precoding at 508 of FIG. 5, or at 710 of FIG. 7. The NE 802 at 808 may also determine a corresponding MCS for a PUSCH transmission using the first precoding. The MCS may be referred to as a reference MCS.

In some aspects, at 810, the NE 802 determines a second precoding based on channel state information. The NE 802 may assume reciprocity between the UL/DL channels and uses the SRS from 806 to determine the second precoding. The second precoding may be referred to as an optimal precoding. The optimal precoding may be based on the channel state information in that the optimal precoding is derived from a channel matrix at the NE 802, as determined from the SRS or reported CSI from the UE 804. An example definition of the optimal precoding may be defined as:

$$w = \frac{1}{\sqrt{r}} [ {v}_{1} , … , {v}_{r} ]$$

In some aspects, v is the i-th right singular vector corresponding to the i-th singular value of the channel matrix in descending order and r is the number of layers for a PUSCH transmission. The right singular vector may be a vector of a singular value decomposition (SVD) matrix derived from the channel matrix. Thus, w may indicate a set of optimal vectors for singular values of the channel matrix.

In some aspects, at 812, the NE 802 may determine a delta MCS based on the second precoding at 810. For example, the delta MCS may be a difference relative to the reference MCS associated with the first precoding determined at 808. In some aspects, the delta MCS may be based on a precoding gain. For example, the delta MCS may indicate how much better of an MCS can be supported at a gain associated with the second precoding than at a gain associated with the first precoding. The precoding gain may be derived as described below.

At 814, the NE 802 sends, and the UE 804 receives, a first indication. The first indication may include a UL grant with a TPMI indicating the first precoding. In some aspects, the first indication comprises a reference MCS associated with the first precoding, and the delta MCS determined at 812 associated with the second precoding. The reference MCS may be the reference MCS determined at 808.

At 818 the UE 804 may select between the first precoding and the second precoding to transmit a PUSCH. The UE 804 may first determine the first precoding based on the TPMI of 814. The UE 804 may determine a second precoding based on channel conditions (e.g., a channel matrix) at the UE 804. The UE 804 may select a selected precoding from the first precoding or the second precoding.

In some aspects, at 820, the UE 804 transmits a second indication, which may be a UCI simultaneously transmitted with PUSCH transmission on granted UL resources indicated in the first indication of 814. For the transmission of the second indication at 820, the UE 804 uses the selected precoding from 818. In some aspects, where the first precoding is selected at 818, then the second indication indicates the first precoding and/or the reference MCS associated with the first precoding. In some aspects, where the UE 804 selects the second precoding at 818, then the second indication may indicate the second precoding and/or the delta MCS. In some aspects, the second indication may include or be associated with an indication of whether the UE 804 has selected the first precoding or the second precoding. For example, the second indication may include a UCI transmission, and the UCI transmission may include a one-bit indication that indicates whether the UE 804 has selected the first precoding or the second precoding.

In some aspects, at 822, the NE 802 decodes the second indication received at 820. The NE 802 may first decode the UCI transmission followed by the PUSCH decoding. If the second indication indicates that the UE 804 has selected the first precoding, the NE 802 may decode the PUSCH transmission using the reference MCS. If the second indication indicates that the UE 804 has selected the second precoding, the UE 804 may decode the PUSCH transmission using an MCS derived from combining the reference MCS and the delta MCS indicated in the first indication.

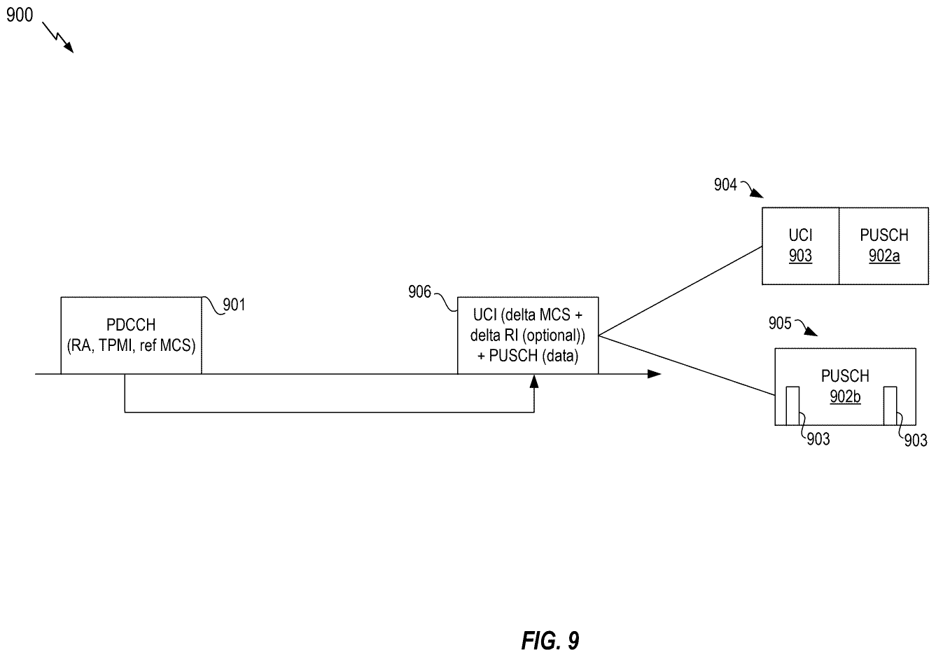

FIG. 9 depicts an example 900 of MCS transmission under a unified UL MIMO framework. FIG. 9 shows example PDCCH and PUSCH transmissions, which may be transmitted by a UE and received by an NE. The NE may be an example of the BS 102 depicted and described with respect to FIG. 1, the first network entity 300 or the second network entity 302 depicted and described with respect to FIG. 3, or a disaggregated base station depicted and described with respect to FIG. 2. An NE may correspond to the NE 702 of FIG. 7 or the NE 802 of FIG. 8. The UE may be an example of UE 104 depicted and described with respect to FIG. 1 or the UE 304 depicted and described with respect to FIG. 3. The UE may correspond to the UE 704 of FIG. 7 or the UE 804 of FIG. 8. However, in other aspects, the UE may be another type of wireless communications device and the NE may be another type of network entity or network node, such as those described herein. Note that any operations or signaling illustrated with dashed lines may indicate that that operation or signaling is an optional or alternative example.

As shown in FIG. 9, at 901, a PDCCH transmission (e.g., DCI) may indicate a TPMI, a reference MCS, and a resource allocation (abbreviated “RA”). For example, the PDCCH transmission may carry a first indication as described with respect to FIGS. 7 and 8. The PDCCH transmission may schedule a UL transmission, which may be transmitted on a PUSCH 902. In the case of CB MIMO techniques described with respect to FIG. 5, the UL transmission is transmitted using the indicated TPMI and reference MCS.

The unified UL MIMO framework of FIGS. 7 and 8 allows the UE to determine or select a second precoding, and to indicate a delta MCS associated with the second precoding (or to provide a one-bit indication of whether the UE has selected the second precoding). The indication of the delta MCS or one-bit indication may be conveyed in a UCI 903. As mentioned, the UCI 903 may be encoded and modulated separately from the PUSCH 902, such that the PUSCH 902 can be decoded and demodulated using information provided via the UCI 903.

In some aspects, as illustrated at 904, the UCI 903 is prefixed to the PUSCH 902a. For example, a first N symbols (or a portion of a first N symbols) of a resource allocation indicated by the PDCCH transmission may be used for the UCI 903 (referred to as a prefixed UCI resource). In some aspects, as illustrated at 905, the UCI 903 is embedded in the PUSCH 902b (referred to as an embedded UCI resource). For example, one or more REs of the resource allocation (e.g., one or more predetermined REs) may be used for the UCI 903. In some aspects, the one or more REs may be near a demodulation reference signal, such as adjacent to an RE of the demodulation reference signal or in a same symbol as the demodulation reference signal.

Aspects described herein are primarily described with regard to an indication of a delta MCS. It should be noted that in aspects described with respect to FIGS. 7-10, a UE can select a rank for a second precoding, and can indicate a difference between a rank indicated by the first indication (e.g., PDCCH) and the selected rank via the second precoding (e.g., the UCI 903). This is illustrated in FIG. 9 as “delta RI.”

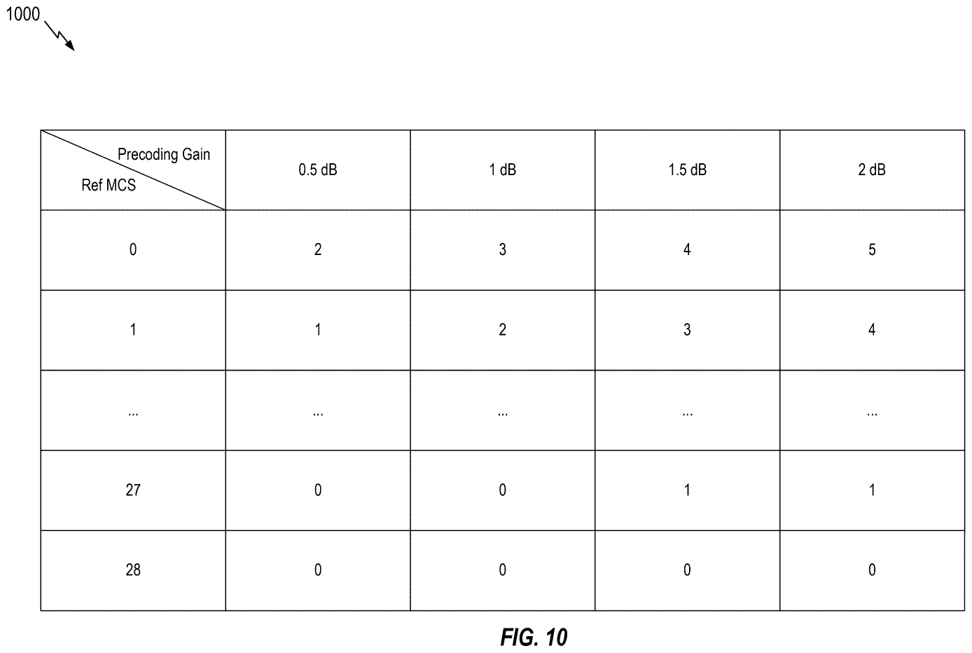

FIG. 10 depicts an example table 1000 to derive a delta MCS by a UE or an NE, such as a UE or an NE described with respect to FIGS. 7-9.

The UE may select a precoding, from a first precoding or a second precoding, based on a precoding gain. A precoding gain indicates a difference in a gain or other metric of a first precoding and a gain or other metric of a second precoding. For example, if a first precoding is expected to provide a gain that is 2 dB worse than a gain of a first precoding, the precoding gain of the second precoding relative to the first precoding is 2 dB. Since the MCS that can be supported by a channel is a function of the gain of the channel, the precoding gain can be used to derive a delta MCS of a second precoding relative to a first precoding.

In some aspects, the UE, calculates the delta MCS based on the mapping of the example table 1000 (though the example table 1000 is just one example of a table that can be used to determine delta MCS). A similar table may be used to determine a delta RI.

The example table 1000 includes columns representing different precoding gains in decibels (dB) and rows representing a reference MCS in terms of an MCS index. The reference MCS represents an MCS that is indicated in a UL grant. Intersecting values represent a delta MCS for each reference MCS based on the corresponding precoding gain. For example if the reference MCS is 0, e.g., in a first precoding, and the precoding gain is 0.5 dB, e.g., from a second precoding relative to the first precoding, then the value of the delta MCS equals 2. In this case, a second precoding may use an MCS index of 0+2=2.

In some aspects, the precoding gain table values are based on the following equation:

$${Gain}_{dB} = 10 log ( ‖ {HP}_{opt} ‖ / ‖ {HP}_{TPMI} ‖ ) ,$$

where H is a channel matrix that is known by the NE (and known by the UE based on a CSI-RS). Pₒₚₜ represents the optimal precoding, e.g., the second precoding derived at 712 of FIG. 7 or at 810 of FIG. 8. P_{TPMI} represents NE derived precoding, e.g., the first precoding determined at 710 of FIG. 7 or at 808 of FIG. 8.

In some aspects, mapping the precoding gain into delta MCS can be based on a UE implementation. For example, the UE can determine a database or table, e.g., the example table 1000, via a rule-based algorithm or UE learning algorithms that associates the precoding gain to a delta MCS. Such a learning algorithm may be trained based on historical information that indicates a precoding gain, a reference MCS, and a delta MCS corresponding to the precoding gain and the reference MCS. Alternatively, such a learning algorithm may be trained based on historical information that indicates gains or other metrics of certain precodings and MCSs of the certain precodings, such that the UE can derive a delta MCS based on two precodings.

In some aspects, the NE provides the information to the UE via RRC signaling. For example, the NE may configure a table, such as the example table 1000, or a rule. For example, the rule may indicate a relationship between a reference MCS, a precoding gain, and a delta MCS.

In some aspects, the UE calculates the delta MCS based on an interference-plus-noise correlation matrix (often denoted Rₙₙ). A interference-plus-noise correlation matrix indicates a correlation between interference-plus-noise components received across multiple antennas of the NE. In some aspects, the NE may signal Rₙₙ, or information associated with or derived from Rₙₙ, to the UE (for example, via a MAC-CE or an RRC). The UE may use this information to derive a delta MCS, for example, by predicting a precoding gain of a second precoding using the interference-plus-noise correlation matrix.

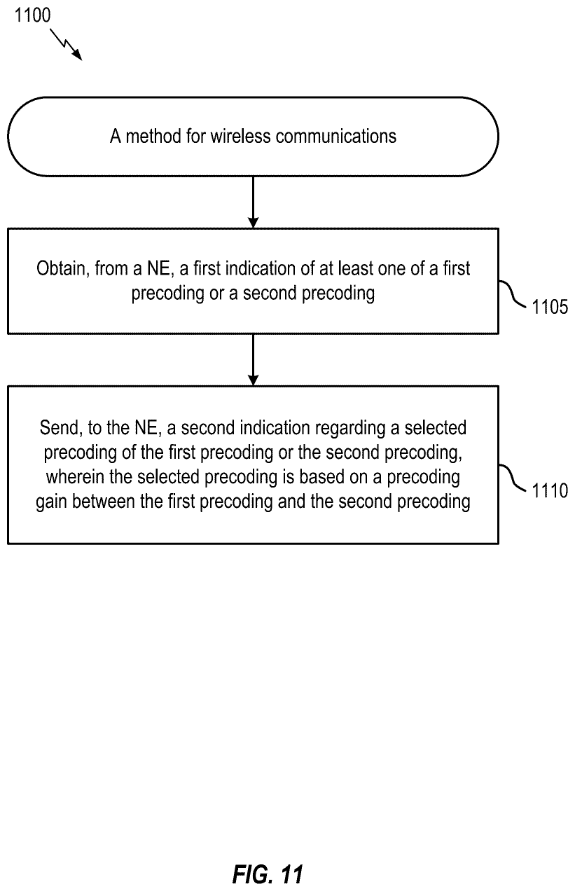

FIG. 11 shows a method 1100 for wireless communications by an apparatus, such as UE 104 of FIG. 1 or UE 304 of FIG. 3.

Method 1100 begins at block 1105 with obtaining, from a NE, a first indication of at least one of a first precoding or a second precoding. The block 1105 may correspond to 714 of FIG. 7 or 814 of FIG. 8. The receiving of the first precoding, the second precoding, or both, improves on latency relative to NCB MIMO techniques. The reduced latency relative to NCB MIMO techniques is due to allowing the UE and the NE to decouple reference signal transmissions from indications of the precoding, for example, by removing sequential dependencies between the reference signals, thus reducing latencies and delays.

Method 1100 then proceeds to block 1110 with sending, to the NE, a second indication regarding a selected precoding of the first precoding or the second precoding, wherein the selected precoding is based on a precoding gain between the first precoding and the second precoding. The block 1110 may correspond to 720 of FIG. 7 or 820 of FIG. 8. The sending of the second indication by the UE that implements the selected precoding improves channel signal strength and quality over CB MIMO techniques, since the precoding used is UE-side selected and not limited to a predefined selection from a CB.

In some aspects, at least one of the first indication or the second indication comprises a reference MCS for the first precoding, and wherein the second indication comprises an MCS difference relative to the first precoding.

In some aspects, method 1100 further includes measuring a CSI-RS to determine the selected precoding.

In some aspects, method 1100 further includes sending an SRS, wherein the first precoding is based on the SRS.

In some aspects, method 1100 further includes selecting the first precoding as the selected precoding, wherein the second indication indicates the first precoding or a MCS associated with the first precoding.

In some aspects, method 1100 further includes selecting the second precoding as the selected precoding, wherein the second indication indicates the second precoding or a MCS difference relative to an MCS of the first precoding.

In some aspects, method 1100 further includes determining the second precoding, wherein the second indication indicates a MCS difference relative to a modulation and coding scheme of the first precoding.

In some aspects, method 1100 further includes sending a PUSCH transmission to the NE using the selected precoding.

In some aspects, the first precoding is codebook based.

In some aspects, the second precoding is an optimal precoding.

In some aspects, block 1110 includes sending the second indication on a PUCCH resource.

In some aspects, the second indication comprises rank information which indicates a difference between an NE-determined rank for the first precoding and a UE-determined rank for the second precoding.

In some aspects, the second indication comprises a difference relative to a MCS of the first precoding.

In some aspects, the second indication is configured to be decoded based on a MCS of the first precoding and a difference relative to a modulation and coding scheme of the first precoding prior to PUSCH decoding.

In some aspects, the PUCCH resource is a prefixed PUCCH resource or an embedded PUCCH resource.

In some aspects, the prefixed PUCCH resource comprises a number of symbols preceding a PUSCH resource.

In some aspects, the embedded PUCCH resource comprises a number of REs within a PUSCH resource.

In some aspects, method 1100 further includes receiving a RRC configuration, wherein block 1110 includes sending the second indication in accordance with the RRC configuration.

In some aspects, method 1100 further includes receiving a MAC-CE, and block 1110 includes sending the second indication in accordance with the MAC-CE.

In some aspects, method 1100 further includes receiving a DCI configuration, and block 1110 includes sending the second indication in accordance with the DCI.

In some aspects, method 1100 further includes determining a difference relative to a MCS of the first precoding based on the precoding gain.

In some aspects, the precoding gain is based on a ratio of a gain, a measurement, or a prediction associated with the second precoding and a gain, a measurement, or a prediction associated with the first precoding.

In some aspects, method 1100 further includes deriving the difference relative to the MCS of the first precoding based on information from the NE received via a RRC configuration.

In some aspects, method 1100 further includes deriving the difference relative to the MCS of the first precoding via at least one of a table or a channel correlation matrix, wherein the difference relative to the MCS of the first precoding is based on the precoding gain.

In some aspects, method 1100 further includes determining the table based on a fixed rule or UE training using a relationship between the difference relative to the MCS of the first precoding and the precoding gain.

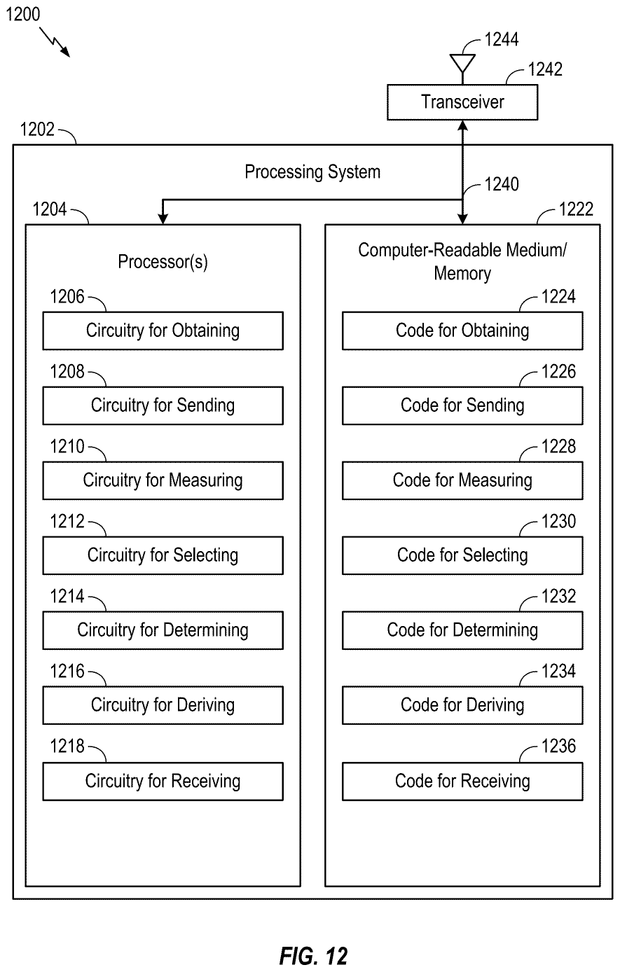

In some aspects, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative operations are possible consistent with this disclosure.

### Example Communications Device

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1202 coupled to a transceiver 1242 (e.g., a transmitter and/or a receiver). The transceiver 1242 is configured to transmit and receive signals for the communications device 1200 via an antenna 1244, such as the various signals as described herein. The processing system 1202 may be configured to perform processing functions for the communications device 1200, including processing signals received and/or to be transmitted by the communications device 1200.

The processing system 1202 includes one or more processors 1204 and a computer-readable medium/memory 1222. In various aspects, the one or more processors 1204 may be representative of the one or more processors 318 described with respect to FIG. 3. The one or more processors 1204 are coupled to a computer-readable medium/memory 1222 via a bus 1240. In some aspects, the computer-readable medium/memory 1222 may be representative of the one or more memories 320 described with respect to FIG. 3. The computer-readable medium/memory 1222 is a non-transitory computer-readable medium/memory. In certain aspects, the computer-readable medium/memory 1222 is configured to store instructions (e.g., computer-executable code), that when executed by the one or more processors 1204, cause the one or more processors 1204 to perform the method 1100 described with respect to FIG. 11, or any aspect related to it, including any operations described in relation to FIG. 11. Note that reference to a processor performing a function of communications device 1200 may include one or more processors performing that function of communications device 1200, such as in a distributed fashion.

In the depicted example, computer-readable medium/memory 1222 stores code (e.g., executable instructions), including code for obtaining 1224, code for sending 1226, code for measuring 1228, code for selecting 1230, code for determining 1232, code for deriving 1234, and code for receiving 1236. Processing of the code 1224-1236 may enable and cause the communications device 1200 to perform the method 1100 described with respect to FIG. 11, or any aspect related to it. For example, in some aspects, code for obtaining 1224 may include code for obtaining, from a NE, a first indication of at least one of a first precoding or a second precoding. In some aspects, code for sending 1226 may include code for sending, to the NE, a second indication regarding a selected precoding of the first precoding or the second precoding, wherein the selected precoding is based on a precoding gain between the first precoding and the second precoding. In some aspects, code for measuring 1228 may include code for measuring a CSI-RS to determine the selected precoding. In some aspects, code for selecting 1230 may include code for selecting the first precoding or the second precoding as the selected precoding. In some aspects, code for determining 1232 may include code for determining the second precoding. In some aspects, code for deriving 1234 may include code for deriving a difference relative to an MCS of the first precoding based on information from the NE received via a RRC configuration.

The one or more processors 1204 include circuitry configured to implement (e.g., execute) the code stored in the computer-readable medium/memory 1222, including circuitry for obtaining 1206, circuitry for sending 1208, circuitry for measuring 1210, circuitry for selecting 1212, circuitry for determining 1214, circuitry for deriving 1216, and circuitry for receiving 1218. Processing with circuitry 1206-1218 may enable and cause the communications device 1200 to perform the method 1100 described with respect to FIG. 11, or any aspect related to it. For example, in some aspects, circuitry for obtaining 1206 may include circuitry for obtaining, from an NE, a first indication of at least one of a first precoding or a second precoding. In some aspects, circuitry for sending 1208 may include circuitry for sending, to the NE, a second indication regarding a selected precoding of the first precoding or the second precoding, wherein the selected precoding is based on a precoding gain between the first precoding and the second precoding. In some aspects, circuitry for measuring 1210 may include circuitry for measuring a CSI-RS to determine the selected precoding. In some aspects, circuitry for selecting 1212 may include circuitry for selecting the first precoding or the second precoding as the selected precoding. In some aspects, circuitry for determining 1214 may include circuitry for determining the second precoding. In some aspects, circuitry for deriving 1216 may include circuitry for deriving a difference relative to an MCS of the first precoding based on information from the NE received via a RRC configuration.

More generally, means for communicating, transmitting, sending or outputting for transmission may include the one or more transceivers 324, one or more antenna 322 and/or processing system 316 of the UE 304 illustrated in FIG. 3, transceiver 1242 and/or antenna 1244 of the communications device 1200 in FIG. 12, and/or one or more processors 1204 of the communications device 1200 in FIG. 12. Means for communicating, receiving or obtaining may include the one or more transceivers 324, one or more antennas 322, and/or processing system 316 of the UE 304 illustrated in FIG. 3, transceiver 1242 and/or antenna 1244 of the communications device 1200 in FIG. 12, and/or one or more processors 1204 of the communications device 1200 in FIG. 12.

### Example Clauses

Implementation examples are described in the following numbered clauses:

Clause 1: A method for wireless communications by a UE comprising: obtaining, from a NE, a first indication of at least one of a first precoding or a second precoding; and sending, to the NE, a second indication regarding a selected precoding of the first precoding or the second precoding, wherein the selected precoding is based on a precoding gain between the first precoding and the second precoding.

Clause 2: The method of Clause 1, wherein at least one of the first indication or the second indication comprises a reference MCS for the first precoding, and wherein the second indication comprises an MCS difference relative to the first precoding.

Clause 3: The method of any one of Clauses 1-2, further comprising measuring a CSI-RS to determine the selected precoding.

Clause 4: The method of any one of Clauses 1-3, further comprising sending an SRS, wherein the first precoding is based on the SRS.

Clause 5: The method of any one of Clauses 1-4, further comprising selecting the first precoding as the selected precoding, wherein the second indication indicates the first precoding or a MCS associated with the first precoding.

Clause 6: The method of any one of Clauses 1-5, further comprising selecting the second precoding as the selected precoding, wherein the second indication indicates the second precoding or a MCS difference relative to an MCS of the first precoding.

Clause 7: The method of any one of Clauses 1-6, further comprising determining the second precoding, wherein the second indication indicates a MCS difference relative to a modulation and coding scheme of the first precoding.

Clause 8: The method of any one of Clauses 1-7, further comprising sending a PUSCH transmission to the NE using the selected precoding.

Clause 9: The method of any one of Clauses 1-8, wherein the first precoding is codebook-based.

Clause 10: The method of any one of Clauses 1-9, wherein the second precoding is an optimal precoding.

Clause 11: The method of any one of Clauses 1-10, wherein sending the second indication comprises sending the second indication on a PUCCH resource.

Clause 12: The method of Clause 11, wherein the second indication comprises rank information which indicates a difference between an NE-determined rank for the first precoding and a UE-determined rank for the second precoding.

Clause 13: The method of Clause 11, wherein the second indication comprises a difference relative to a MCS of the first precoding.

Clause 14: The method of Clause 11, wherein the second indication is configured to be decoded based on a MCS of the first precoding and a difference relative to a modulation and coding scheme of the first precoding prior to PUSCH decoding.

Clause 15: The method of Clause 11, wherein the PUCCH resource is a prefixed PUCCH resource or an embedded PUCCH resource.

Clause 16: The method of Clause 15, wherein the prefixed PUCCH resource comprises a number of symbols preceding a PUSCH resource.

Clause 17: The method of Clause 15, wherein the embedded PUCCH resource comprises a number of REs within a PUSCH resource.

Clause 18: The method of any one of Clauses 1-17, further comprising receiving a RRC configuration, wherein sending the second indication comprises sending the second indication in accordance with the RRC configuration.

Clause 19: The method of any one of Clauses 1-18, further comprising receiving a MAC-CE configuration, and wherein sending the second indication comprises sending the second indication in accordance with the MAC-CE.

Clause 20: The method of any one of Clauses 1-19, further comprising receiving a DCI configuration, and wherein sending the second indication comprises sending the second indication in accordance with the DCI.

Clause 21: The method of any one of Clauses 1-20, further comprising determining a difference relative to a MCS of the first precoding based on the precoding gain.

Clause 22: The method of Clause 21, wherein the precoding gain is based on a ratio of a gain, a measurement, or a prediction associated with the second precoding and a gain, a measurement, or a prediction associated with the first precoding.

Clause 23: The method of Clause 21, further comprising deriving the difference relative to the MCS of the first precoding based on information from the NE received via a RRC configuration.

Clause 24: The method of Clause 21, further comprising deriving the difference relative to the MCS of the first precoding via at least one of a table or a channel correlation matrix, wherein the difference relative to the MCS of the first precoding is based on the precoding gain.

Clause 25: The method of Clause 24, further comprising determining the table based on a fixed rule or UE training using a relationship between the difference relative to the MCS of the first precoding and the precoding gain.

Clause 26: One or more apparatuses, comprising: one or more memories comprising executable instructions; and one or more processors configured to execute the executable instructions and cause the one or more apparatuses to perform a method in accordance with any one of Clauses 1-25.

Clause 27: One or more apparatuses configured for wireless communications, comprising: one or more memories; and one or more processors, coupled to the one or more memories, configured to cause the one or more apparatuses to perform a method in accordance with any one of Clauses 1-25.

Clause 28: One or more apparatuses configured for wireless communications, comprising: one or more memories; and one or more processors, coupled to the one or more memories, configured to perform a method in accordance with any one of Clauses 1-25.

Clause 29: One or more apparatuses, comprising means for performing a method in accordance with any one of Clauses 1-25.

Clause 30: One or more non-transitory computer-readable media comprising executable instructions that, when executed by one or more processors of one or more apparatuses, cause the one or more apparatuses to perform a method in accordance with any one of Clauses 1-25.

Clause 31: One or more computer program products embodied on one or more computer-readable storage media comprising code for performing a method in accordance with any one of Clauses 1-25.

Clause 32: One or more apparatuses configured for wireless communications, comprising: a processing system that includes one or more processors and one or more memories coupled with the one or more processors, the processing system configured to cause the one or more apparatuses to perform a method in accordance with any one of Clauses 1-25.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to:
obtain, from a network entity (NE), a first indication of at least one of a first precoding or a second precoding; and
send, to the NE, a second indication regarding a selected precoding of the first precoding or the second precoding, wherein the selected precoding is based on a precoding gain between the first precoding and the second precoding.

2. The apparatus of claim 1, wherein the processing system is further configured to measure a channel state information reference signal (CSI-RS) to determine the selected precoding.

3. The apparatus of claim 1, wherein the processing system is configured to send a sounding reference signal (SRS), wherein the first precoding is based on the SRS.

4. The apparatus of claim 1, wherein the processing system is further configured to select the first precoding as the selected precoding, wherein the second indication indicates the first precoding or a modulation and coding scheme (MCS) associated with the first precoding.

5. The apparatus of claim 1, wherein the processing system is further configured to select the second precoding as the selected precoding, wherein the second indication indicates the second precoding or a modulation and coding scheme (MCS) difference relative to an MCS of the first precoding.

6. The apparatus of claim 1, wherein the processing system is further configured to determine the second precoding, wherein the second indication indicates a modulation and coding scheme (MCS) difference relative to a modulation and coding scheme of the first precoding.

7. The apparatus of claim 1, wherein the processing system is configured to send a physical uplink shared channel (PUSCH) transmission to the NE using the selected precoding.

8. The apparatus of claim 1, wherein the first precoding is codebook based.

9. The apparatus of claim 1, wherein to send the second indication, the processing system is configured to send the second indication on an uplink control information (UCI) resource.

10. The apparatus of claim 9, wherein the second indication comprises a difference relative to a modulation and coding scheme (MCS) of the first precoding.

11. The apparatus of claim 9, wherein the UCI resource is a prefixed UCI resource or an embedded UCI resource.

12. The apparatus of claim 11, wherein the prefixed UCI resource comprises a number of symbols preceding a physical uplink shared channel (PUSCH) resource.

13. The apparatus of claim 11, wherein the embedded UCI resource comprises a number of resource elements (REs) within a physical uplink shared channel (PUSCH) resource.

14. The apparatus of claim 1, wherein the processing system is further configured to receive:
a radio resource control (RRC) configuration, wherein to send the second indication, the processing system is configured to send the second indication in accordance with the RRC configuration, or
a medium access control control element (MAC-CE), and wherein to send the second indication, the processing system is configured to send the second indication in accordance with the MAC-CE, or
a downlink control information (DCI), and wherein to send the second indication, the processing system is configured to send the second indication in accordance with the DCI.

15. The apparatus of claim 1, wherein the processing system is further configured to determine a difference relative to a modulation and coding scheme (MCS) of the first precoding based on the precoding gain.

16. The apparatus of claim 15, wherein the processing system is configured to derive the difference relative to the MCS of the first precoding based on:
information from the NE received via a radio resource control (RRC) configuration, or
at least one of a table or a channel correlation matrix, wherein the difference relative to the MCS of the first precoding is based on the precoding gain.

17. A method for wireless communication, comprising:
obtaining, from a network entity (NE), a first indication of at least one of a first precoding or a second precoding; and
sending, to the NE, a second indication regarding a selected precoding of the first precoding or the second precoding, wherein the selected precoding is based on a precoding gain between the first precoding and the second precoding.

18. The method of claim 17, wherein at least one of the first indication or the second indication comprises a reference modulation and coding scheme (MCS) for the first precoding, and wherein the second indication comprises an MCS difference relative to the first precoding.

19. An apparatus for wireless communication, comprising:
means for obtaining, from a network entity (NE), a first indication of at least one of a first precoding or a second precoding; and
means for sending, to the NE, a second indication regarding a selected precoding of the first precoding or the second precoding, wherein the selected precoding is based on a precoding gain between the first precoding and the second precoding.

20. The apparatus of claim 19, wherein at least one of the first indication or the second indication comprises a reference modulation and coding scheme (MCS) for the first precoding, and wherein the second indication comprises an MCS difference relative to the reference MCS for the first precoding.
